(19) United States
(12) Patent Application Publication
(10) Pub. No.: US 2019/0147404 A1
(43) Pub. Date: May 16, 2019

(54) EMAIL STREAMING RECORDS

(71) Applicant: Salesforce.com, inc., San Francisco, CA (US)

(72) Inventors: Erik Lue, San Francisco, CA (US); Pratima Arora, Sunnyvale, CA (US); Nima Motamedi, Toronto (CA); Tao Chen, Emeryville, CA (US); Aaron Zhang, Richmond Hill (CA); Aaron Quan, Vaughan Ontario (CA); Roshni Datta, Union City, CA (US); Parin Kenia, Sunnyvale, CA (US); David Buccola, Pleasanton, CA (US); Shaahin Rushan, Dublin, CA (US); Kasthuri Periyakoil, Campbell, CA (US); Kedar Doshi, Palo Alto, CA (US); Scott Goldstein, Concord, CA (US); Dmitri Limonov, Dublin, CA (US)

(21) Appl. No.: 15/814,671

(22) Filed: Nov. 16, 2017

(51) Int. Cl. G06Q 10/10; H04L 12/58

(52) U.S. Cl. CPC G06Q 10/107; H04L 51/046; H04L 51/36

(57) ABSTRACT

An analysis service may crawl communication events occurring on an organization-wide application. The analysis service may analyze the events to determine communication events that are relevant to a record of a management application of the organization. The analysis service may generate data points for the record based on analysis of the communication events of the organization. The relevant communication events and data points may provide contexts to users of the management application.

### BACKGROUND

An organization's communication systems often operate across a variety of media and with a variety of users and outside contacts. It is often beneficial for a given user to have access to communication events involving other users in order to provide context for the given user's decisions. For example, a given user in an organization may communicate with a particular outside contact and need to know information exchanged between that particular contact and another user in the organization. Typically, contextualizing user communication events for generalized reference requires some form of user interaction at the time of or after the communication event occurs. For example a user of an email application may be required to install an application component or browser component that prompts the user for interaction before data from a received email can be made available to other organizational users.

### BRIEF DESCRIPTION OF THE DRAWINGS

The accompanying drawings, which are included to provide a further understanding of the disclosure, are incorporated in and constitute a part of this specification. The drawings also illustrate implementations and embodiments of the disclosure and together with the detailed description serve to explain the principles of implementations and embodiments of the disclosure. No attempt is made to show structural details in more detail than may be necessary for a fundamental understanding of the disclosure and various ways in which it may be practiced.

FIG. 1 shows an example system diagram of a component environment according to an implementation of this disclosure.

FIG. 2 shows an example system diagram of the relationship between communication events, relevant communication events, data points, and records according to an implementation of this disclosure.

FIG. 3 shows an example procedure for determining relevant communication events according to an implementation of this disclosure.

FIG. 4 shows an example procedure for generating data points according to an implementation of this disclosure.

FIG. 5 shows an example procedure for determining relevant communication events according to an implementation of this disclosure.

FIG. 6 shows an example procedure for generating data points according to an implementation of this disclosure.

FIG. 7 shows an example computing device according to an implementation of this disclosure.

FIG. 8 shows an example network arrangement according to an implementation of this disclosure.

### DETAILED DESCRIPTION

Communication systems of organizations can be tasked with managing millions of user communication events. For example an organization may manage voice calls, video conferences, calendar events, emails, text messages, and any number of social media communication events of the organization's users. As discussed above it may be beneficial to make information contained in a given user's communications available for providing context to other users.

It may also be beneficial to analyze an organization's communication events in the aggregate to generate useful data points, such as predictions, recommendations, statistics, and related information. Such data points can provide a richer context to inform organizational users. However, in light of the extensive quantity and types of communication events, it may not be possible to efficiently process a significant portion of an organization's aggregate events without expending significant processing resources or a significant amount of time. Thus it may be beneficial to determine a subset of communication events relevant to a particular record of the organization. The subset of relevant communication events can be analyzed more efficiently and thus generate data points that are more temporally relevant when accessed by the user.

To address issues such as those described above, in implementations of this disclosure an analysis service may access one or more communication systems of an organization to provide context for users in the organization. For example, a user can grant the analysis service access to the user's account on a calendar application. The user may also have an account on a management application that manages records of transactions of the organization. The analysis service can access the calendar application via an application programming interface (API) and search the calendar application based on search criteria associated with a record of the management application. The analysis service can determine relevant communication events occurring via the calendar application such as meetings attended by organizational users and outside attendees who are associated with the record. The relevant communication events can be associated with the record such as in a timeline of communication events provided by the record.

The analysis service can process the relevant communication events and generate data points for the record. For example, a data point can be an indicator of how long it has been since a user contacted an outside attendee, a recommendation of further action, a prediction of a future event related to the record, or a proposal for collaboration with other users. The record may be provided in an interface of the management application in conjunction with an interface of the calendar application. In this way, the analysis service can provide contextual information to the user.

### Component Environment

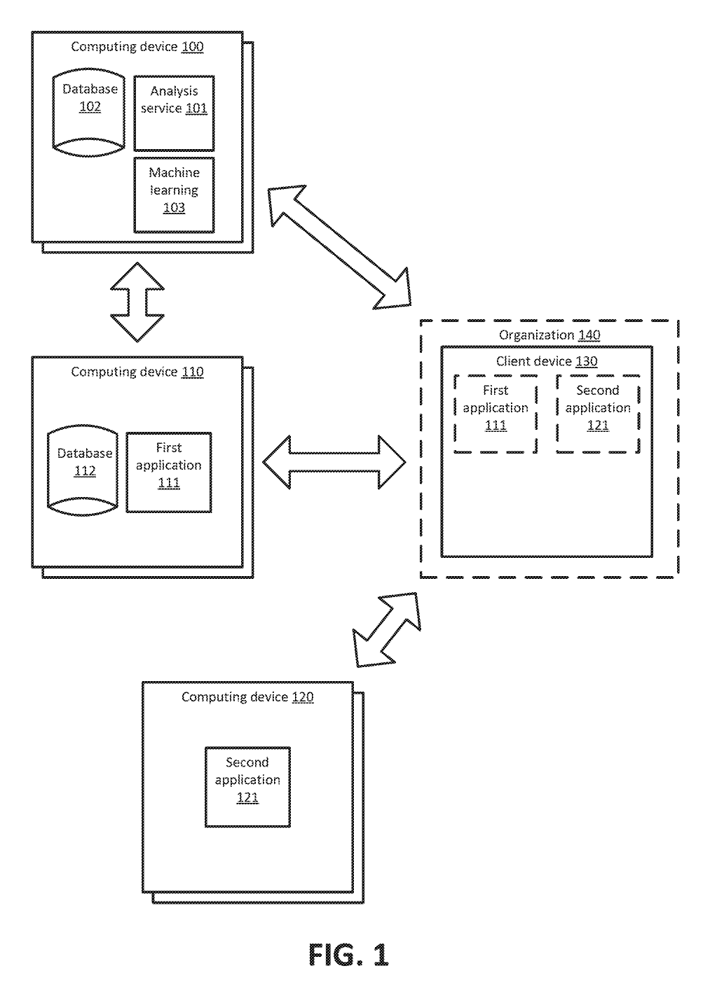

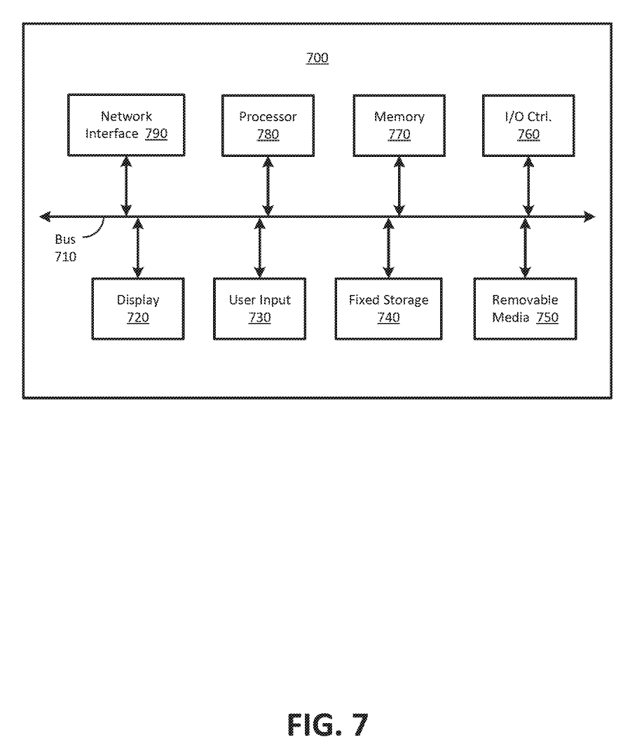

Implementations of this disclosure may be executed in a variety of component environments. For example, FIG. 1 shows an example system diagram of a component environment according to an implementation of this disclosure. Analysis service 101 may include instructions executing on the set of one or more computing devices 100. Computing device 100 and any other computing device discussed herein may include any arrangement of hardware and/or software suitable for the purposes of this disclosure, such as any of those discussed with respect to FIG. 7 below. For example, computing device 100 may include a processor, storage device, and related components on a single physical device or a virtualized processing component, storage component, and related components distributed across multiple physical devices.

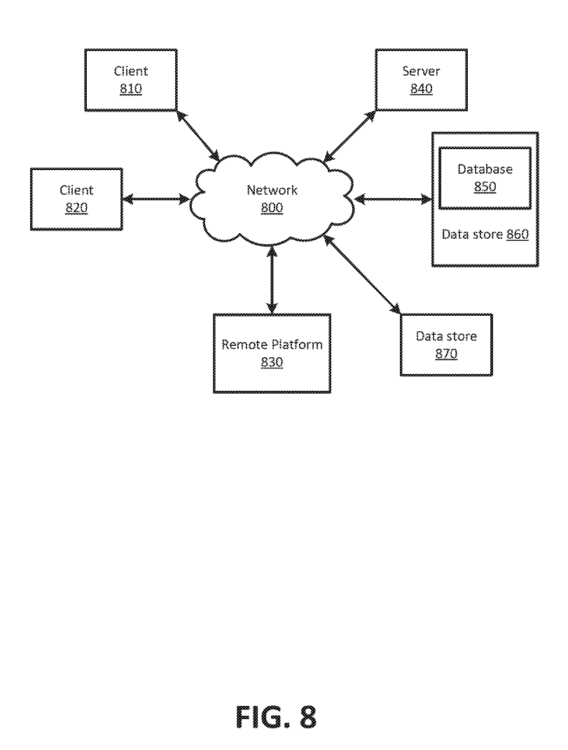

Analysis service 101 may operate in communication with database 102. Database 102 may include management procedures and data structures executing on the set of one or more computing devices 100. In general, database 102 and any other database discussed herein may include any structured arrangement of data that persists in data and metadata and that is suitable for the purposes of this disclosure, such as any of those discussed with respect to FIG. 8 below. For example, in some implementations database 102 may be a Microsoft Azure® SQL cloud database, Amazon® AWS cloud database, Postgres database, Mysql Server database, Oracle® 12c database, Apache HBase™ database, Bigtable™ database, MongoDB™ database, or other NoSQL database. In some implementations, analysis service 101 may select a set of one or more available computing devices that are closest to organization 140 and may implement Database 102 on the selected computing devices.

In implementations of this disclosure, analysis service 101 may access machine learning system 103 to perform certain operations such as those used for determining data points. Machine learning system 103 may be implemented on one or more computing devices 100, or machine learning system 103 may be implemented on one or more computing devices remote from computing devices 100, such as in a remote cloud computing environment accessible over a suitable communication network such as any of those discussed below with respect to FIG. 8.

In general, machine learning system 103 may include any arrangement of hardware and/or software suitable for the purposes of this disclosure. For example, machine learning system 103 can implement machine learning techniques such as decision tree learning, association rule learning, deep neural networks, inductive logic programming, support vector machines, cluster analysis, Bayesian networks, reinforcement learning, representation learning, similarity learning, sparse dictionary learning, genetic algorithms, rule-based learning, and learning classifier systems. Machine learning system 103 can execute machine learning tasks such as supervised learning, unsupervised learning, semi-supervised learning, reinforcement learning, developmental learning, classification, regression, clustering, density estimation, dimensionality reduction, topic modeling, or related machine learning tasks.

Analysis service 101 may be in communication with first application 111 over a suitable communications network such as any of those discussed below with respect to FIG. 8. In some implementations, analysis service 101 can directly interface with first application 111. In other implementations, analysis service 101 can interface with first application 111 via an API. Communications between analysis service 101 and first application 111 may secured by encryption techniques such as a key/secret token pair. First application may include instructions executing on one or more computing devices 110. For example, first application 111 may be a management application that manages records of organization 140, such as a business contacts, business opportunities, or customer accounts. Records of organization 140 can be stored in database 112 which may be implemented on the set of one or more computing devices 110. Examples of first application 111 may include Cirrus™ Insight applications and Microsoft® Dynamics applications.

First application 111 may provide indicators related to records to client device 130 over any suitable communications network, such as any of those discussed below with respect to FIG. 8. Client device 130 may be any computing device suitable for the purposes of this disclosure, such as any of those discussed below with respect to FIGS. 7 and 8. For example, client device may be a tablet, smart phone, laptop, smart watch, or personal computer.

First application 111 may execute in conjunction with second application 121. For example, second application 121 may be an email application executing on one or more computing devices 120 and have an interface provided to client device 130. When the second application 121 receives an email, first application 111 may display via an interface, an indicator of a communication event within a record relevant to that email on client device 130, such as an account record of a customer for whom the sender is the sales representative. In general, in implementations of this disclosure, analysis service 101 may execute procedures for querying communication events, determining relevant communication events, and generating data points. Procedures for associating relevant communication events and data points with records and displaying records may be executed by first application 111.

In some implementations computing devices 100 and 110 may be the same set of computing device components, share some of the same computing device components, or be distinct computing device components. In some implementations, database 102 and database 112 may be the same database, share some of the same database components, or be distinct databases. Further, in some implementations, analysis service 101 and first application 111 may be components of the same system, such as where analysis service 101 and first application 111 are components of the same application provided as a software service to communication systems of organization 140. In other implementations, first application 111 may be provided as a software service to communications systems of organization 140, and analysis service 101 may be provided as a software service to first application 111 and/or to communication systems of organization 140.

In some implementations computing devices 100, 110, and 120; and databases 102 and 112 may be the same, partially the same, or distinct computing devices and databases. In some implementations a single organization may provide analysis service 101, first application 111, and second application 121 as a software service to organization 140. In such implementations analysis service 101, first application 111, and/or second application 121 may be components of the same system.

### Communication Events, Data Points, and Records

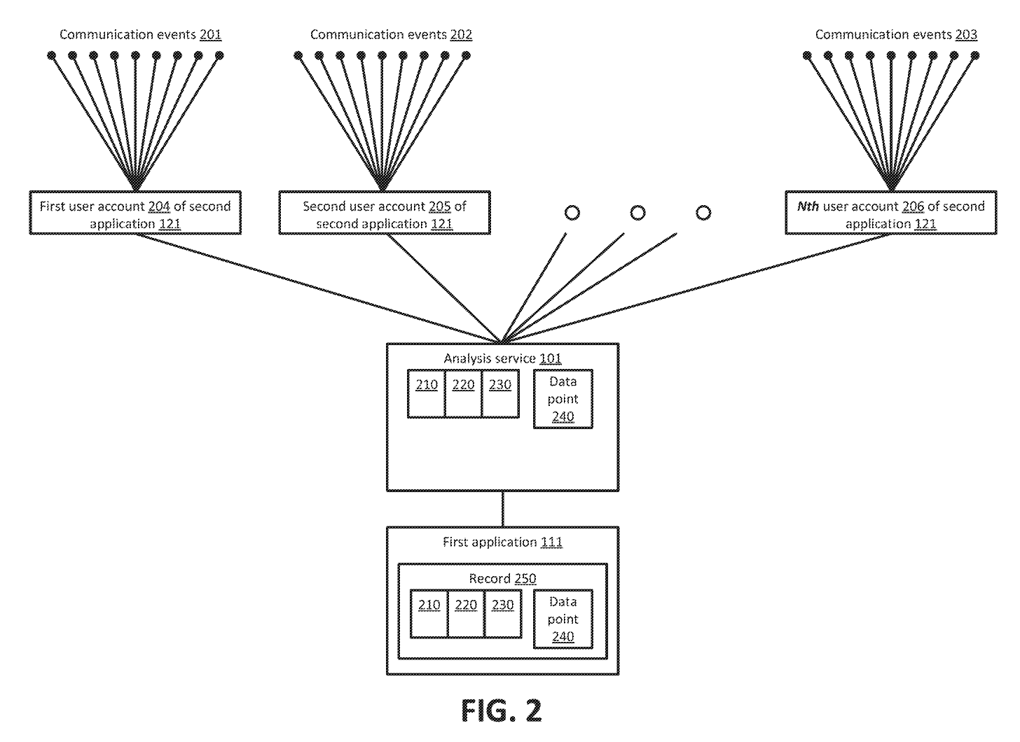

In implementations of this disclosure, communication events may be analyzed to determine relevancy and generate data points for inclusion in records. FIG. 2 shows an example system diagram showing the relationships between communication events, relevant communication events, data points, and records according to an implementation of this disclosure.

In an implementation, an organization, such as organization 140, may provide a communication system to its users such as second application 121. In implementations of this disclosure second application 121 may be an application such as an email application, calendar application, voice call application, video conference application, text messaging application, or social media application, or any application that implements or facilitates communication. For example, second application may be Microsoft® Outlook 365 email and calendar, Microsoft® Exchange, Google® Gmail email, Google® Calendar, Amazon® WorkMail email, Skype® voice communication service, Snapchat® image messaging service, Twitter® social networking service, Instagram® photo-sharing service, Facebook® social networking service, Linkedin® social networking service, and WhatsApp® instant messaging service.

Second application 121 may grant access to users of organization 140 via multiple user accounts, such as first user account 204, second user account 205, . . . through arbitrary Nth user account 206 (See FIG. 2). Communication events, such as communication events 201, 202, 203 may transpire via second application 121. For example, first user account 204 may receive an email, accept a calendar meeting request, generate a Facebook post, place a Skype call, or transmit a Snapchat message. Generally, any communication that is sent or received via second application 121 and that is suitable for the purposes of this disclosure may constitute a communication event 201, 202, 203. In some implementations, communication events 201, 202, 203 may be referred to as ‘activities’.

In general, a user of second application 121 may select permissions granting access to some, all, or none of communication events occurring via second application 121. As a result of these permissions, analysis service 101 may access and analyze some, all, or none of the user's communication events and present the same via an interface of first application 111. In some implementations, each user of first application 111 may access communication events for which permissions were granted and which are determined to be relevant to a record or data points calculated for the record. For example, analysis service 101 may generate a data point based on communication events involving only a first user and an out of organization contact. An indicator of the data point may be viewable in an instance of first application 111 of a distinct second user of organization 140.

In some implementations, first application 111 may access multiple second applications 121 and analyze communication events occurring over the multiple second application 121 in the aggregate by employing any of the procedures discussed herein. If access to second application 121 is disconnected, then past communication events accessed by first application 111 may still be available to first application 111.

In some implementations, first application 111 may also provide permission configuration functionality to users. For example, users having user accounts 204, 205, 206 may all grant or be required to grant access to communication events, such as relevant communication events 210, 220, 230 occurring via second application 121. However, a user of first application 111 may choose permissions on first application 111 to restrict display of some or all of the contents of communication events for which the user is a participant, for example a sender, recipient, commenter, or attendee.

In some implementations, some or all users in organization 140 may use second application 121. Second application 121 may be, for example, an email application. A subset of the users of the email application may elect to grant access to and function as a user of the first application 111. For example, first application 111 may be a management application that can interface with the email application, and only the sales team of organization 140 may be elect to use the management application.

In general it may be beneficial to make some basic information about all communication events relevant to any record in first application 111 available to all users of first application 111. In some implementations, analysis service 101 may have access to some or all data in communication events 201, 202, 203 by default. User accounts 204, 205, 206 may default to providing access to certain basic information about a users' communication events 201, 202, 203 to analysis service 101 without requiring permission. For example, a communication event 201 may be an email having a “Time/date:”, “To:” field, “From:” field, “Subject:” field, “Cc:” field, and “Bcc:” field, as well as the body of the email. The basic information available to analysis service 101 may include the “Time/date:”, “To:”, “From:”, “Subject:”, “Cc:”, and “Bcc:” fields, but the body of the email may be restricted. Similar basic information may be available as a default for other types of communication events. For example, basic information for a Twitter post may be the “Time/date:”, “Username:”, and “@handle:” fields, but the message of the tweet and any links or attachments may be restricted; basic information for a calendar meeting may be the “Organizer:”, “Subject:”, “Location:”, “Start time/date:”, “End time/date:”, and “Attendees” fields, but the body of the meeting invitation and any links or attachments may be restricted; basic information for a Linkedin post may be “Name:”, “Headline:”, “Time/date:” fields; but the body of the post and any links or attachments may be restricted; and basic information for a voice call may be the “Caller number:”, “Callee number:”, “Start time/date:”, “End time/date:”, and “Duration:” fields, but the content of the call may be restricted. Similar basic information may be made available for any communication event discussed herein.

In some implementations, restricted information in a communication event may be accessible to analysis service 101 for the purposes of executing operations on the restricted information, but analysis service 101 may be restricted from publishing the restricted information to a record of first application 111, such as record 250. For example, analysis service 101 may have access to restricted information of communication events 210, 220, and 230. The results of the analysis of the restricted information may be made available to some or all users of first application 111, such as in the form of a data point in a record, but, for example, only basic information of the communication event may be available in record 250.

Once analysis service 101 obtains access to communication events 201, 202, 203, then, in some implementations, analysis service 101 can crawl communication events 201, 202, 203 such as by searching against the communication events in order to determine whether any events are relevant to a given record. For example, in some implementations, analysis service 101 can execute a query against communication events 201, 202, 203 at a storage device associated with second application 121. In some implementations, analysis service 101 can copy all communication events 201, 202, 203 from their storage location to database 102 or database 112 and execute a query against database 102 or 112. In some implementations, historical communication events may be crawled initially and then real-time crawling may operate on communication events as they occur.

Analysis service 101 can determine relevant communication events 210, 220, 230 as a result of searching against communication events 201, 202, 203. For example, in an implementation, analysis service 102 can search communication events 201, 202, 203 for relevancy criteria associated with record 250. As a result, communication events 210, 220, 230 can be determined to be relevant communication events.

In an implementation of this disclosure, once analysis service 101 determines relevant communication events 210, 220, 230, then analysis service 101 can associate relevant communication events 210, 220, 230 with record 250 in first application 111. For example, first application 111 may be a management application that manages records of organization 140, including record 250. Analysis service 101 can associate relevant communication events 210, 220, 230 with record 250 and store the associated events and updated record in database 102 or 112. In some implementations, analysis service 101 may determine relevant communication events, such as relevant communication events 210, 220, 230 and provide indicators of the relevant communication events to first application 111. In response, first application 111 may associate the relevant communication events with a record in first application 111, such as record 250.

Associating an entity or an association between entities can include referencing, cross-referencing, linking, coupling, storing in or with, or otherwise relating one entity with or to another entity, such as in a database. For example associating relevant communication event 210 with record 250 may include storing relevant communication event 210 in record 250 or otherwise establishing a relationship between relevant communication event 210 and record 250 such that relevant communication event 210 can be accessed when record 250 is accessed.

In general, in implementations of this disclosure, a record such as record 250 may be any arrangement of data of an organization such as organization 140 that is suitable for the purposes of this disclosure. For example, record 250 may store data related to product development; projects; design options; demonstrations; software code; testing; financial accounts; quotes; invoicing; training procedures; business intelligence; a contact outside of organization 140, such as a business partner point of contact; a contact inside of organization 140, such as an employee or user of organization 140; a contact of a transaction opportunity, such as a business contact or potential customer; a transaction opportunity, such as a business lead or request for proposal; an ongoing transaction, such as a contract; a completed transaction; a set of one or more of: contacts, potential transaction opportunities, ongoing transactions, and/or completed transactions, for example a customer account storing various business dealings with the customer; or a record may be an object customized by a user of organization 140.

In implementations of this disclosure, first application 111 or an administrator or other user of first application 111 may assign users of first application 111 to a record of application 111, such as record 250. For example, a set of users may constitute a software development team for an organization 140. A request for proposal may be issued for a type of software related to the development team's expertise. First application 111 may generate an opportunity record for the request for proposal, and because of the development team's expertise, the set of users may be assigned to the opportunity record.

According to implementations of this disclosure, a particular user of first application 111 may control which other users of first application 111 may access the particular user's communication events, such as relevant communication events 210, 220, 230 stored in record 250. Access may be controlled by a particular user, for example, by selecting permissions granting or denying access to other specific users or groups of users. For example, a particular user may specify tailored access such as where another can see all communications of the particular user, no communications of the particular user, or only certain types of communications of the particular user. In some implementations, first application 111 or an administrator or other user of first application 111 may specify access controls for the particular user or for a group of users. In some implementations, users may self-organize into groups and specify differing levels of access to their communication events to users inside and outside of the group.

According to implementations of this disclosure, a particular user may control access, for example, by maintaining a list of other users or contacts where the participation of a listed user or listed contact in the particular user's communication event can determine whether that communication event is accessible or inaccessible to other users in the organization. For example, a whitelist may be a list of users whose participation with a particular user in a communication event will enable other users in an organization to view that communication event when accessing an associated record. A blacklist may be a list of users whose participation with a particular user in a particular communication event will disable other users in an organization from viewing the particular communication event when accessing an associated record.

Blacklists, whitelists, and related permission schemes may control access to communication events in a variety of ways according to implementations of this disclosure. For example according to an implementation of this disclosure, there may be a first user, a second user, and a third user in an organization such as organization 140. The first user may send a text message to the second user. The first user may also maintain a blacklist that includes the second user. The text message may be determined by analysis service 101 to be a communication event relevant to a particular record such as record 250 and associated with that particular record. When the third user accesses the particular record, she will not have access to the text message because the first user is a participant in the text message and has included the second user in the first user's black list.

In another example according to an implementation of this disclosure, there may be a first user and a second user of an organization such as organization 140. For example, the first user and the second user may be employees of organization 140. There may also be a contact outside of the organization, such as an engineering consultant. The first user and second user may conduct a meeting with the outside contact and the meeting may be organized in a calendar event. The calendar event may be determined by analysis service 101 to be a communication event relevant to a particular record such as record 250 and associated with that particular record. The first user may include the outside contact on her blacklist and the second user may not include the outside contact on her blacklist. In this circumstance, when a third user in the organization views the particular record, she may access the calendar event because the second user had not included the outside contact on her blacklist. In circumstances where both the first user and the second user include the outside contact on their respective blacklists, then the third user may be prevented from viewing the calendar event when she access the particular record.

In another example, in some implementations a first user of application 111 who is on a second user's blacklist may be restricted from viewing some or all of the contents of the first user's communication events, even when the communication events are published in a record in application 111 that is available to other users.

In some implementations, specific emails or domains for organization 140 may be included in a blacklist that applies to all users of application 111. For example, an administrator of application 111 may include an email domain or other indicator that is specific to organization 140 on an organization-wide blacklist. Thus, in this way communication events between users in organization 140 may be prevented from being associated with a record displayed in application 111.

In some implementations of this disclosure, a first user who is restricted from viewing a second user's communication event may request access from the second user. The second user may provide access, for example by adjusting sharing permissions specific to the first user. In general, access to communication events as discussed herein may be controlled according to any combination of permissions or similar controls that are suitable for the purposes of this disclosure.

First application 111 may include or interface with an organizational social networking service or message board service for some or all users of the organization. For example the social networking feature may generate groups having specified sharing permissions, such as whitelists, blacklists, or tailored access as discussed above. In some implementations, a user of first application 111 may apply the sharing permissions specified for the user's social networking service to the user's communication events in first application 111 to enable the access control functionality discussed above. In some implementations, the social networking service or message board service may map its sharing permissions to the access control permissions for the user's communication events.

In implementations of this disclosure, analysis service 101 can execute operations on relevant communication events 210, 220, 230 to generate data points, such as data point 240 and associate data points, such as data point 240, with record 250. For example, record 250 may be a customer account and relevant communication events 210, 220, 230 may be the only three emails an employee of organization 140 has exchanged with the sales representative of the customer. Analysis service 101 may calculate the amount of time since the most recent email exchange and generate a data point 240 representing that amount of time. Analysis service 101 can store, couple, link, or otherwise associate data point 240 with record 250 and store the associated data point and updated record in database 102 or 112.

Analysis service 101 can provide relevant communication events 210, 220, 230 and data point 240 to first application 111 for display in record 250 on client device 140, according to an implementation of this disclosure.

### Analysis Procedures

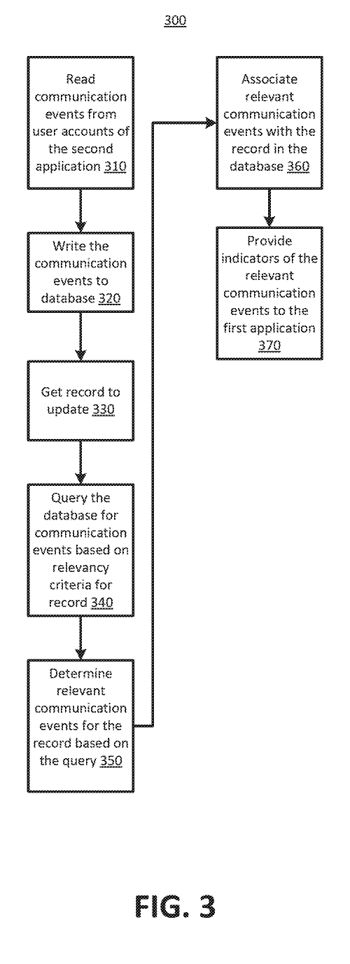

Implementations of this disclosure may execute various analysis procedures to determine relevant communication events. For example, FIG. 3 shows an example procedure 300 for determining relevant communication events according to an implementation of this disclosure. At 310, analysis service 101 can read communication events 201, 202, 203 from user accounts 204, 205, 206 of second application 121. As discussed above, second application 121 may be, for example, an email application for users in organization 140, and communication events 201, 202, 203 may be, for example, sent and received emails. At 320, analysis service 101 can store communication events 201, 202, 203 in a database such as database 102.

At 330, analysis service 101 can access first application 111 to get a record to update, such as record 250. As discussed above, record 250 may be, for example, a contact record storing the name, contact information, or contact history for a person outside of organization 140, such as a business contact. Record 250 may be read from or provided by first application 111, such as via database 112. In some implementations, analysis service 101 may read record 250 from database 102. For example, records managed by first application 111 and maintained in database 112 may be mirrored or otherwise replicated to database 102. Generally, database 112 can be the database of record or source of truth for a given record managed by first application 111, although a version of the given record may also be stored in database 102. Records may be selected for update based on a schedule, cycle, period of time since last update, manual selection, or by any other selection procedure that is suitable for the purposes of this disclosure and that may be executed by or in conjunction with analysis service 101 or first application 111.

In implementations of this disclosure, analysis service 101, executing on one or more computing devices 100, can determine based on relevancy criteria whether a particular communication event of a set of communication events associated with a user in organization 140 is relevant to record 250 of first application 111. For example, at 340 analysis service 101 can query the set of communication events stored in database 140 for communication events that include relevancy criteria. The communication events returned by the query may be deemed relevant communication events, and thus at 350, analysis service 101 can determine relevant communication events for record 250 based on the query.

Relevancy criteria may include any criteria that may serve as a basis for searching against a set of data and that is suitable for the purposes of this disclosure. For example relevancy criteria for a business contact record can include the email address and name of the person stored as the business contact in the record. A set of email communication events may be searched for emails having the email address criteria or name criteria, and all emails having the email address criteria or the name criteria may be returned by analysis service 101. These returned emails may be deemed relevant communication events.

In general, in implementations of this disclosure, relevancy criteria may include: a recipient associated with a communication event, a sender associated with a communication event, a participant associated with a communication event, a subject associated with a communication event, a keyword associated with a communication event, a sentiment associated with a communication event, a date associated with a communication event, a time associated with a communication event, an organization associated with a communication event, or a communication type associated with a communication event.

As another example, relevancy criteria for a business lead record can include the names, email addresses, and other contact information of the users in the organization who are assigned to the lead; and the names, email addresses, phone numbers, text messaging username, social media usernames, social media handles, and other contact information of persons stored as the contact for the lead. A set of email communication events, social media communication events, and text message communication events may be searched for communication events having some or all of such relevancy criteria, and all events having such relevancy criteria may be returned by analysis service 101. These returned communication events can be deemed relevant communication events.

As another example, relevancy criteria for a business opportunity record can include the names, email addresses, and other contact information of the users in the organization who are assigned to that opportunity; the names, email addresses, and other contact information of the business contacts who represent outside organizations that are a part of the opportunity; and the name of the opportunity, the outside organizations, or other keywords related to the opportunity. A set of email communications, voice communications, calendar events, text messages, social media communications, or other communication events discussed herein can be searched for events having some or all of such relevancy criteria, and all events having such relevancy criteria may be returned by analysis service 101. These returned communication events may be deemed relevant communication events.

As another example, relevancy criteria for an account record may include the names, email addresses, and other contact information of the users in the organization who are assigned to that account; the names, email addresses, and other contact information of the business contacts who represent outside organizations that are a part of the account; the names of the account, outside organizations, and contracts performed under the account; contract numbers for contracts performed under the account; any indicia or other index associated with any relevancy criteria such as employee numbers, customer number, document codes, and so forth; or other keywords related to the account. A set of email communications, voice communications, calendar events, text messages, social media communications, or other communication events discussed herein can be searched for events having some or all of such relevancy criteria and all events having such relevancy criteria may be returned by analysis service 101. These returned communication events may be deemed relevant communication events.

In general, any suitable combination of relevancy criteria that is beneficial in identifying relevant communication events may be specified. For example, a business opportunity record may include multiple contacts for an outside organization, however only a particular contact may be responsible for the particular opportunity included in the record. As a result, only the particular contacts' name, email address, and related contact information may serve as relevancy criteria for the opportunity record. As another example, data ranges or other periods of time may serve as relevancy criteria. Thus, for example, the returned relevant communication events described in any of the aforementioned examples may be restricted to only those communication events also having a time stamp or otherwise indicated to have occurred within a specified time range criteria.

In some implementations, relevancy criteria may be selected and set as a configuration of analysis service 101 by an administrator or other user of organization 140 or otherwise predetermined and stored in association with a respective record. For example, when record 250 is accessed by analysis service 101, relevancy criteria for record 250 may also be accessed. In some implementations, relevancy criteria may be determined by analysis service 101. For example, a new record may be generated by first application 111 and the contents of certain populated fields in record 250 may be accessed by analysis service 101 and selected as relevancy criteria. For example, the “point of contact name:”, “email address:”, “phone number:”, and “organization name:” fields of a business contact record may be accessed and stored as relevancy criteria for that record. In some implementations, machine learning system 103 may generate relevancy criteria. Further discussion of the generation of relevancy criteria by machine learning system 103 is included in later portions of this specification.

Returning to FIG. 3, in implementations of this disclosure, once relevant communication events have been determined, analysis service 101 may associate the relevant communication events with the record at 360. In some implementations, analysis service 101 executing on the one or more computing devices 100 can store a relevant communication event in database 102. For example, a relevant email communication event may be added to a business contact record and stored as an updated version of that record in database 102 and reconciled with database 112. In some implementations, the updated version of the record may be stored first in database 112 and replicated to database 102.

At 370, analysis service 101 may provide indicators of the relevant communication events to the first application. For example, in some implementations, analysis service 101 may provide an indicator of a relevant communication event directly to the record in first application 111 at client device 130. In some implementation, when a record of first application 111 is requested to be loaded at client device 130, relevant communication events may be determined by analysis service 101 and indicators of the relevant communication events may be provided to first application 111 for insertion into the record.

In some implementations, providing an indicator of a relevant communication event may include updating the version of the record in database 102, which may then replicate to database 112 and thereby update the record in first application 111 to include an indicator of the relevant communication event. In some implementations, providing an indicator of a relevant communication event may include updating the version of the record directly in database 112 and thereby update the record in first application 111 to include an indicator of the relevant communication event. An indicator may include any representation of the relevant communication event that is suitable for the purposes of this disclosure. For example, an indicator may include the contents, network link, symbol, icon, thumbnail, title, summary, date, and so forth related to the relevant communication event.

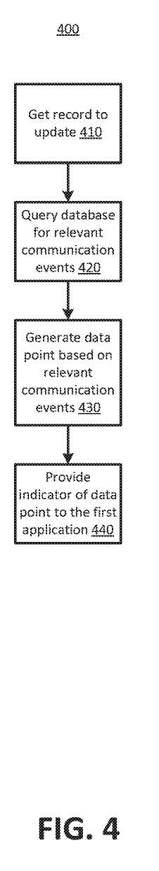

Implementations of this disclosure may execute various analysis procedures to generate data points based on relevant communication events. For example, FIG. 4 shows an example procedure 400 for generating data points according to an implementation of this disclosure. At 410, analysis service 101 can get a record to update, such as record 250, and query a database 102 for relevant communication events. Analysis service 101 may determine relevant communication events in any manner explicitly or implicitly described in this disclosure.

At 430 analysis service 101 can generate a data point based on the determined relevant communication events. For example, in some implementations, analysis service 101 executing on one or more computing devices 100 can generate a data point for a record based on a first relevant communication event associated with a first user and a second relevant communication event associated with a second user of a set of users of organization 140. The first relevant communication event may be, for example, an email received by the first user from a business contact of an opportunity record and the second relevant communication event may be a phone call from the second user to the business contact. Analysis service 101 may determine a time of occurrence for the first and second communication events. Analysis service 101 can calculate the amount of time since the most recent communication event of the first and second communication events. This amount of time may be the period of time since a most recent communication to a recipient associated with a communication event. Analysis service 101 may generate a data point representing or otherwise communicating this period of time.

The data point may include any representation of information that is calculated from communication events and that is suitable for the purposes of the disclosure. For example, a data point may include a quantity of communications to a recipient associated with a communication event. Hence, for example, a data point representing the quantity of communications in the preceding example may be two. In another example, a data point may be a quantity of communication events within a specified period of time, for example an “intensity” of communication events, or a quantity of communication events from a particular sender within a specified period of time, for example a “density” of communication events. In another example, a data point may be a recommendation based on dates or statements in prior communication events. For example, if a communication event includes the words “reschedule” then, analysis service 101 can provide a data point showing open meeting times; if a communication event includes the phrase “send me the presentation”, then analysis service 101 can provide data points having links to recent presentations; or if a communication event includes a product name, then a data point linking to records concerning that product may be presented by analysis service 101.

As another example, a data point may be a suggested recipient of a communication outside of an organization. For example, analysis service 101 may identify topics within relevant communication events based on parameters such as frequency of occurrence, predetermined keywords, synonyms, or techniques such as natural language processing. Analysis service 101 may determine other potential contacts outside of an organization based on this topic. For example, relevant communication events for a business opportunity record may include the phrase “PHP development” at a relatively high frequency compared to other similar repeated words or the word “PHP” may be a predetermined keyword for the record that generates recommendations if it is present in relevant communication events. As a result, analysis service 101 may search web pages, blogs, and social networks containing language indicating a person or organization is offering service related to the topic “PHP development”. Analysis service 101 may then generate a data point indicating and/or linking to the search result and suggesting that a user contact the person or entity offering PHP development services. In this way, a user accessing the record may be presented with a context to more efficiently identify personnel and business partners to assist in effectively pursuing the business opportunity.

As another example, a data point may be a suggested recipient of a communication inside of the organization. For example, analysis service 101 may identify topics within relevant communication events, such as in the manner discussed above, and determine a potential contact within the organization based on this topic. For example, the business opportunity record described above may specify three users in an organization as the team handling the business opportunity. The users may not be aware that another user in the organization has previously provided PHP development services under a contract for the organization. An indicator of this contract may be stored in an account record along with keywords, including “PHP”. Analysis service 101 may query the organizations records stored in database 102 or 112 for records related to the determined topic “PHP development”. As a result the user having PHP development experience may be identified. Analysis service 101 may then generate a data point indicating and/or linking to the search result and suggesting that the users on the team contact the user with PHP development experience.

As another example, a data point may be a measure of interconnectedness between users in an organization. For example, users within the organization may be mapped to a social graph. The links between users in the graph may be stronger or weaker commensurate with the quantity and/or weight of connections between them. For example, there may be several users in the organization with PHP development experience. However, a particular user may be assigned to several other records to which the team members are also assigned whereas the other users with PHP development experience are not, or the particular user may have multiple times the experience of the other users with PHP development experience. The number of common records or years of experience may correspond to a measure of interconnectedness. As a result, each user having PHP experience may be identified along with their respective measures of interconnectedness, or in some implementations, only the particular user having the higher measure of interconnectedness may be identified. Analysis service 101 may then generate a data point indicating and/or linking to the search result and suggesting that the users on the team contact the users/user with PHP development experience.

As another example, a data point may be a suggested event. For example, as discussed above a topic may be determined to be “PHP development”. Analysis service 101 may search records of an organization, internal organization networks, websites, blogs, and social networks for events related to the topic. For example, a public PHP developers conference and a meeting within the organization that involves PHP development may be identified. As a result analysis service 101 may generate data points indicating and/or linking to the identified events and suggesting the users on the team attend.

As another example, a data point may be a reminder for a user to perform an action. For example, analysis service 101 may identify a phrase or punctuation within an email or text message communication event, such as a question mark. Analysis service 101 may determine that a user was a recipient of the email or text message communication event and has not replied to the email or text message. As a result, analysis service 101 may generate a data point indicating and/or linking to the identified email or text message and suggesting to the user that she should respond.

Returning to FIG. 4, analysis service 101 executing on one or more computing devices 100 may associate the data point with the record and provide an indicator of the generated data point to the first application 111 at 440. In some implementations, the provision of the data point may be in response to a request received from first application 111. In some implementations the provision of the data point may be executed independent of a request from first application 111. Associating the data point with the record and providing an indicator of the data point to the first application can be executed in accordance with the procedures discussed throughout this specification.

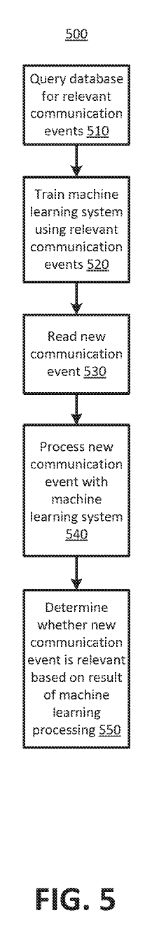

Implementations of this disclosure may execute various machine learning procedures, to determine relevant communication events for a record. For example, FIG. 5 shows an example procedure 500 for determining relevant communication events according to an implementation of this disclosure. In general any suitable machine learning techniques discussed here may be employed to determine relevant communication events for a record.

At 510 analysis service 510 can query a database such as database 102 to determine relevant communication events. At 520, machine learning system 103 may be trained using the determined relevant communication events. For example, a set of communication events including the communication events relevant to the record may be input to nodes of a back propagation, multi-layer neural network. The neural network may process the set of events and extract characteristic features present within the relevant communication events. These characteristic features may be used to adjust weights applied to the nodes of the neural network. As a result the trained neural network may be employed to predict whether a new communication event is relevant to the record.

At 530, a new communication event may be read or received by analysis service 101. Analysis service 101 may provide the new communication event to trained machine learning system 103 at 540. Trained machine learning system 103 may process the new communication event for relevancy to the record. As a result, at 550, trained machine learning system 103 may determine whether the new communication event is relevant to the record and provide an indicator of the determination to analysis service 101. For example, the prediction of trained machine learning system 103 may be a score for the new communication event, such as a relevancy score. The relevancy score may be compared to a threshold relevancy value. If the relevancy value is exceeded, then the new communication event may be determined to be a relevant communication event.

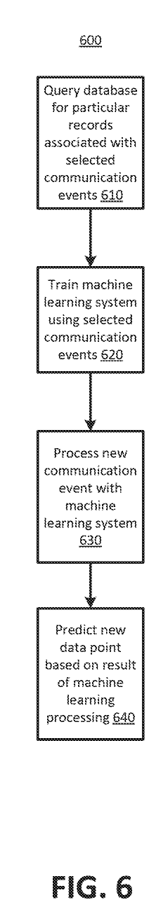

Implementations of this disclosure may execute various machine learning procedures to generate data points for a record. For example, FIG. 6 shows an example procedure 600 for generating a data point for a record according to an implementation of this disclosure. In general any suitable machine learning techniques discussed herein may be employed to generate data points for a record.

At 610, analysis service 101 can query a database such as database 102 to identify particular records associated with a selected communication event, such as a communication event indicating successful contract performance, a communication event indicating a new client, or a communication event indicating a failed negotiation. At 620, machine learning system 103 may be trained using a set of communication events including those of particular records storing the selected communication event. For example the set of communication events may be input to nodes of a back propagation, multi-layer neural network. The neural network may process the set of communication events to extract characteristic features present within the communication events of the particular records. These characteristic features may be used to adjust weights applied to the nodes of the neural network. As a result the trained neural network may be employed to predict whether a new communication event is indicative of an issue indicated in the selected communication event. For example, communication events indicative of significant delays or acceleration in response times between communications, or sentiments such as anger or enthusiasm may serve as the basis for generating a data point recommending a warning or future action to users of a record.

Analysis service 101 may receive a new communication event and provide the new communication event to trained machine learning system 103. At 630 trained machine learning system may process the new communication event. As a result, at 640, trained machine learning system 103 may predict a new data point for the record and provide an indicator of the data point to analysis service 101.

### Other Components

Implementations of the disclosure may be implemented in and used with a variety of component and network architectures. FIG. 7 is an example computing device 700, suitable for implementations of the disclosure. Computing devices, such as computing device 700, may include computers, servers, mainframes, desktops, laptops, tablets, smart phones, wearable devices, and other computing devices. The computing device 700 includes a bus 710 which interconnects major components of the computing device 700, such as a central processor 780, a memory 770 (typically RAM, but which may also include ROM, flash RAM, or the like), an input/output controller 760, a user display 720, such as a display screen via a display adapter, a user input interface 730, which may include one or more controllers and associated user input devices such as a keyboard, mouse, and the like, and may be closely coupled to the I/O controller 760, fixed storage 740, such as a hard drive, flash storage, Fibre Channel network, SAN device, SCSI device, and the like, and a removable media component 750 operative to control and receive an optical disk, flash drive, and the like.

The bus 710 allows data communication between the central processor 780 and the memory 770, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computing device 700 are generally stored on and accessed via a computer-readable medium, such as a hard disk drive (e.g., fixed storage 740), an optical drive, floppy disk, or other storage medium.

The fixed storage 740 may be integral with the computing device 700 or may be separate and accessed through other interfaces. A network interface 790 may provide a direct connection to a remote server via a telephone link, to the Internet via an internet service provider (ISP), or a direct connection to a remote server via a direct network link to the Internet via a POP (point of presence) or other technique. The network interface 790 may provide such connection using wireless techniques, including digital cellular telephone connection, Cellular Digital Packet Data (CDPD) connection, digital satellite data connection or the like. For example, the network interface 790 may allow the computing device to communicate with other computing devices via one or more local, wide-area, or other networks, as shown in FIG. 8.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computing device such as that shown in FIG. 7 is readily known in the art and is not discussed in detail in this application. Code or instructions to implement this disclosure can be stored in computer-readable storage media such as one or more of the memory 770, fixed storage 740, removable media 750, or on a remote storage location.

FIG. 8 shows an example network arrangement according to an implementation of the disclosure. One or more clients 810, 820, such as local computing devices, smart phones, tablet computing devices, and the like may connect to other devices via one or more networks 800. The network may be a local network, wide-area network, the Internet, or any other suitable communication network or networks, and may be implemented on any suitable platform including wired and/or wireless networks. The clients may communicate with one or more servers 840 and/or databases 850. The devices may be directly accessible by the clients 810, 820, or one or more other devices may provide intermediary access such as where a server 840 provides access to resources stored in a database 850. Database 850 may be implemented on a data store 860, whereas data store 870 may store data in a non-database format. A data store may be any suitable combination of hardware and software for storing structured and/or unstructured data. The clients 810, 820 also may access remote platforms 830 or services provided by remote platforms 830 such as cloud computing arrangements and services. The remote platform 830 may include one or more servers and/or databases.

In various implementations of this disclosure, computing device 700 may function as any of the one or more computing devices 100, 110, 120 and the client device 130 discussed above with respect to FIGS. 1-6, and components of network arrangement 800 may provide connectivity and other functionality discussed above with respect to FIGS. 1-6, such as among computing devices 100, 110, 120, client device 130, databases 102, 112, and machine learning system 103.

More generally, various implementations of this disclosure may include or be implemented in the form of computer-implemented procedures or processes and apparatuses for practicing those processes. Implementations also may be implemented in the form of a computing device program product having instructions or computer program code containing instructions implemented in non-transitory and/or tangible media, such as floppy diskettes, CD-ROMs, hard drives, USB (universal serial bus) drives, or any other machine readable storage medium, wherein, when the computing device program code is loaded into and executed by a computing device, the computing device becomes an apparatus for practicing implementations of the disclosure.

Implementations also may be implemented in the form of computer program code, for example, whether stored in a storage medium, loaded into and/or executed by a computing device, or transmitted over some transmission medium, such as over electrical wiring or cabling, through fiber optics, or via electromagnetic radiation, wherein when the computer program code is loaded into and executed by a computing device, the computing device becomes an apparatus for practicing implementations of the disclosure. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosure in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosure.

The foregoing description, for purpose of explanation, has been described with reference to specific implementations. However, the illustrative discussions above are not intended to be exhaustive or to limit implementations of the disclosure to the precise forms disclosed. Many modifications and variations are possible in view of the above teachings. The implementations were chosen and described in order to explain the principles of implementations of the disclosure and their practical applications, to thereby enable others skilled in the art to utilize those implementations as well as various implementations with various modifications as may be suited to the particular use contemplated.

1. A method comprising:
determining, by one or more first computing devices, that a first communication event that is associated with a first user of a first plurality of users in a first organization is relevant to a first record of a first application based on relevancy criteria;
storing, by the one or more first computing devices, the first communication event in a database implemented on a storage device in communication with the one or more first computing devices;
generating, by the one or more first computing devices, a data point for the first record based on the first communication event and at least a second communication event stored in the database, the second communication event associated with a second user of the first plurality of users and determined to be relevant to the first record; and
providing, by the one or more first computing devices to the first application, an indicator of the data point in response to a request received from the first application.

2. The method of claim 1, wherein the first communication event is selected from the group consisting of: an email, a calendar event, a social media interaction, a telephone call, a text message, and a video conference interaction.

3. The method of claim 1, wherein the first communication event occurs via a second application executing on one or more second computing devices that are distinct from the one or more first computing devices.

4. The method of claim 1, wherein:
the first communication event occurs via a second application executing on one or more second computing devices that are distinct from the one or more first computing devices; and
the first application executes on one or more third computing devices that are distinct from the one or more first computing devices and the one or more second computing devices.

5. The method of claim 1, wherein:
the first communication event occurs via a second application executing on one or more second computing devices that are distinct from the one or more first computing devices;
the first organization includes a second plurality of users of the second application; and
the second plurality of users comprise the first plurality of users.

6. The method of claim 1, wherein:
the first communication event occurs via a second application; and
a second organization provides the first application and the second application.

7. The method of claim 1, wherein the first record is selected from the group consisting of: a contact outside of the organization; a contact inside of the organization; a contact of a transaction opportunity; a transaction opportunity; an ongoing transaction; a completed transaction; a plurality of: contacts, potential transaction opportunities, ongoing transactions, and/or completed transactions; and an object customized by a user of the first organization.

8. The method of claim 1, wherein the relevancy criteria comprise at least one selected from the group consisting of: a recipient associated with the first communication event, a sender associated with the first communication event, a participant associated with the first communication event, a subject associated with the first communication event, a keyword associated with the first communication event, a sentiment associated with the first communication event, a date associated with the first communication event, a time associated with the first communication event, an organization associated with the first communication event, and a communication type associated with the first communication event.

9. The method of claim 1, wherein:
the determination that the first communication event is relevant to the first record comprises:
processing by a machine learning system in communication with the one or more first computing devices, the first communication event, and
generating, by the machine learning system, a relevance value for the first communication event based on a result of the processed first communication event; and
the determination that the first communication event is relevant to the first record is based on the relevance value.

10. The method of claim 1, wherein storing the first communication event in the database comprises:
associating, by the one or more first computing devices, the first communication event with the first record; and
storing, by the one or more first computing devices, the first record with the associated first communication event in the database.

11. The method of claim 1, wherein the data point comprises at least one selected from the group consisting of: a period of time since a most recent communication to a recipient associated with the first communication event, a quantity of communications to a recipient associated with the first communication event, a suggested recipient of a communication outside of the organization, a suggested recipient of a communication inside of the organization, a suggested event, a reminder for the first user to perform an action, and a measure of interconnection between the first user and a third user of the plurality of users.

12. The method of claim 1, wherein the generation of the data point comprises:
processing, by a machine learning system that is trained on data comprising the second communication event and that is in communication with the one or more first computing devices, the first communication event; and
predicting, by the machine learning system, the data point based on a result of the processed first communication event.

13. The method of claim 1, wherein the first user is the second user.

14. The method of claim 1, wherein the first user is distinct from the second user.

15. The method of claim 1, wherein the provision of the indicator of the data point comprises:
providing the indicator of the data point to an instance of the first application associated with an account of a third user of the first plurality of users that has permissions to view the data point.

16. The method of claim 1, wherein:
each user of the first plurality of users has access to sender data, recipient data, and subject data associated with each communication event of the first record; and
only users of the first plurality of users having an account with permissions have access to the data point of the first record.

17. The method of claim 1, wherein the provision of the indicator of the data point comprises providing the indicator of the data point for display via an interface of the first application.

18. The method of claim 1, wherein:
the first communication event occurs via the first application; and
the provision of the indicator of the data point comprises providing the indicator for display via an interface of the first application in conjunction with a display of an indicator of the first communication event.

19. The method of claim 1, wherein:
the first communication event occurs via a second application distinct from the first application; and
the provision of the indicator of the data point comprises providing the indicator for display via an interface of the first application in conjunction with display of an interface of the second application.

20. A non-transitory, computer-readable medium storing instructions that when executed by a processor, cause the processor to perform operations comprising:
determining, by one or more first computing devices, that a first communication event that is associated with a first user of a first plurality of users in a first organization is relevant to a first record of a first application based on relevancy criteria;
storing, by the one or more first computing devices, the first communications event in a database implemented on a storage device in communication with the one or more first computing devices;
generating, by the one or more first computing devices, a data point for the first record based on the first communication event and at least a second communication event stored in the database, the second communication event associated with a second user of the first plurality of users and determined to be relevant to the first record; and
providing, by the one or more first computing devices to the first application, an indicator of the data point in response to a request received from the first application.

21. A system comprising:
one or more first computing devices comprising a processor; and
a non-transitory, computer-readable medium storing instructions that when executed by the processor, cause the processor to perform operations comprising:
determining, by the one or more first computing devices, that a first communication event that is associated with a first user of a first plurality of users in a first organization is relevant to a first record of a first application based on relevancy criteria;
storing, by the one or more first computing devices, the first communications event in a database implemented on a storage device in communication with the one or more first computing devices;
generating, by the one or more first computing devices, a data point for the first record based on the first communication event and at least a second communication event stored in the database, the second communication event associated with a second user of the first plurality of users and determined to be relevant to the first record; and
providing, by the one or more first computing devices to the first application, an indicator of the data point in response to a request received from the first application.
